(19) United States
(12) Patent Application Publication
(10) Pub. No.: US 2024/0171092 A1
(43) Pub. Date: May 23, 2024

(54) VIBRATION ACTUATOR AND METHOD FOR MANUFACTURING VIBRATION ACTUATOR

(71) Applicant: CANON KABUSHIKI KAISHA, Tokyo (JP)

(72) Inventors: YUKI ODA, Kanagawa (JP); ATSUSHI KIMURA, Chiba (JP); SATOSHI TSUCHIYA, Saitama (JP)

(21) Appl. No.: 18/506,862

(22) Filed: Nov. 10, 2023

(30) Foreign Application Priority Data
Nov. 18, 2022 (JP) 2022-185025

(51) Int. Cl. H02N 2/10; H02N 2/00

(52) U.S. Cl. CPC H02N 2/103; H02N 2/22; G03B 5/00

(57) ABSTRACT

A vibration actuator includes a vibrator, a contact body, at least one pair of first extensions, and at least one pair of second extensions. The vibrator includes a rectangular elastic body and an electromechanical energy transducer. The contact body comes into contact with the rectangular elastic body and the contact body and the vibrator move relative to each other due to vibration of the vibrator. The at least one pair of first extensions is disposed on each of two long sides of the rectangular elastic body, and protrudes in a direction intersecting a long-side direction of the rectangular elastic body. The at least one pair of second extensions is disposed on each of two short sides of the rectangular elastic body, and protrudes in a direction intersecting a short-side direction of the rectangular elastic body.

### BACKGROUND

### Field

The present disclosure relates to a vibration actuator that brings a contact body into press contact with a vibrator for frictional driving, and a method for manufacturing the vibration actuator.

### Description of the Related Art

A vibration actuator includes a vibrator and a contact body that is configured to come into press contact with the vibrator. The vibrator includes an elastic body and an electromechanical energy transducer, such as a piezoelectric element, that is bonded to the elastic body. The vibration actuator is used as a vibration wave motor that causes a relative movement of the contact body using friction resulting from the driving force of vibration excited in the vibrator. Examples of the vibration actuator include a linear vibration actuator that performs linear driving.

For example, the linear vibration actuator includes projections on the surface of the rectangular vibrator. The contact body and the projections are brought into press contact with each other, and a predetermined alternating-current voltage is applied to the electromechanical energy transducer for driving. Generating an elliptic motion or circular motion at the ends of the projections on the surface causes the contact body and the vibrator to move relative to each other. The elliptic motion or circular motion generated at the ends of the projections due to the contact body receiving a frictional driving force from the projections enables the vibrator and the contact body to move relative to each other.

A method for generating an elliptic motion or circular motion at the ends of the projections in such a vibration actuator will now be described.

FIGS. 19A and 19B illustrate two bending vibration modes of a vibrator 501. The vibrator 501 includes an elastic body 504 and projections 506. A piezoelectric element 505, which is an electromechanical energy transducer, is bonded to the vibrator 501.

FIG. 19A illustrates one of the two bending vibration modes (which is referred to as an A-mode). The A-mode involves a second-order bending motion in a long-side direction (a direction indicated by a double-headed arrow X) of the vibrator 501 having a rectangular shape, with three nodal lines parallel to a short-side direction thereof (a direction indicated by a double-headed arrow Y).

The projections 506 are disposed near the positions of nodes of vibration in the A-mode and reciprocate in the direction indicated by the double-headed arrow X due to the vibration in the A-mode.

FIG. 19B illustrates the other of the two bending vibration modes (which is referred to as a B-mode). The B-mode involves first-order bending vibration in the short-side direction (the direction indicated by the double-headed arrow Y) of the vibrator 501 having the rectangular shape, with two nodal lines parallel to the long-side direction (the direction indicated by the double-headed arrow X).

The nodal lines in the A-mode and the nodal lines in the B-mode are formed to be substantially orthogonal to each other within the XY plane.

The projections 506 are disposed near the position of an antinode of vibration in the B-mode and reciprocate in a direction indicated by a double-headed arrow Z due to the vibration in the B-mode.

Generating the vibrations in the foregoing A- and B-modes with a predetermined phase difference can cause an elliptic motion at the ends of the projections 506, whereby a driving force in the direction indicated by the double-headed arrow X in FIG. 19A can be applied. A not-illustrated flexible printed circuit board is bonded to the piezoelectric element 505, and the two bending vibration modes can be generated by application of alternating-current voltages to the piezoelectric element 505 from the flexible printed circuit board.

As described above, the vibration actuator combines the A-mode and the B-mode to cause an elliptic motion. In this case, to ensure stable driving, it is important to confine a difference Δf (Δf=f_{A}−f_{B}) between a natural frequency f_{A} for exciting the A-mode and a natural frequency f_{B} for exciting the B-mode within a predetermined range. However, the difference Δf may deviate from the predetermined range because of factors such as a machining error. Further, if the difference Δf varies largely among individual vibration actuators, the vibration actuators may be unable to offer sufficient performance unless the driving method of the vibration actuators is tailored to each individual vibration actuator, depending on the driving method. This can interfere with driving the vibration actuators using the same driving method.

As a method for adjusting the natural frequencies f_{A} and f_{B} in the respective modes, for example, Japanese Patent Application Laid-Open No. 2019-187093 discusses a method for confining variations in the difference Δf due to the natural frequencies f_{A} and f_{B} within a predetermined range by machining a part of the projections.

However, since the method discussed in Japanese Patent Application Laid-Open No. 2019-187093 includes machining the projections themselves, the projections need to have a certain amount of height. If the projection height of the vibrator is reduced to miniaturize the vibration actuator, the machining for adjusting the difference Δf becomes difficult.

### SUMMARY

The present disclosure is directed to a vibration actuator that can be manufactured with high yield even in a case where the projection height of a vibrator is reduced to make the vibration actuator low-profile.

According to an aspect of the present disclosure, a vibration actuator includes a vibrator including a rectangular elastic body and an electromechanical energy transducer, a contact body configured to come into contact with the rectangular elastic body, wherein the contact body and the vibrator are configured to move relative to each other due to vibration of the vibrator, at least one pair of first extensions disposed on each of two long sides of the rectangular elastic body, and protruding in a direction intersecting a long-side direction of the rectangular elastic body, and at least one pair of second extensions disposed on each of two short sides of the rectangular elastic body, and protruding in a direction intersecting a short-side direction of the rectangular elastic body.

Further features of the present disclosure will become apparent from the following description of exemplary embodiments with reference to the attached drawings.

### BRIEF DESCRIPTION OF THE DRAWINGS

FIG. 1 is an exploded perspective view of a vibration actuator according to a first exemplary embodiment of the present disclosure.

FIG. 2 is a perspective view illustrating a configuration of the vibration actuator according to the first exemplary embodiment.

FIG. 3 is a view illustrating a vibrator according to the first exemplary embodiment.

FIG. 4 is a view illustrating a method for retaining the vibrator according to the first exemplary embodiment.

FIG. 5 is views illustrating a finite element method (FEM) analysis result on deformations in two natural vibration modes of the vibrator according to the first exemplary embodiment.

FIG. 6 is a graph illustrating an example of a relationship among an extension length, natural frequencies, and a difference Δf of the vibrator according to the first exemplary embodiment.

FIG. 7 is a flowchart illustrating an example of a procedure for machining extensions according to the first exemplary embodiment.

FIG. 8 is a perspective view illustrating a configuration of a vibrator similar to that according to the first exemplary embodiment.

FIG. 9 is a graph illustrating an example of a relationship among an extension length, natural frequencies, and a difference Δf of the vibrator similar to that according to the first exemplary embodiment.

FIGS. 10A and 10B are views illustrating a method for retaining a vibrator according to a second exemplary embodiment.

FIG. 11 is a view illustrating a configuration of the vibrator according to the second exemplary embodiment.

FIG. 12 is a view illustrating another method for retaining the vibrator according to the second exemplary embodiment.

FIG. 13 is a view illustrating another configuration of the vibrator according to the second exemplary embodiment.

FIG. 14 is a graph illustrating an example of a relationship among an extension length, natural frequencies, and a difference Δf of the vibrator according to the second exemplary embodiment.

FIG. 15 is a flowchart illustrating a procedure for machining extensions according to the second exemplary embodiment.

FIG. 16 is a view illustrating a configuration using a plurality of the vibration actuators according to the first or second exemplary embodiment.

FIG. 17 is a view illustrating an example where the vibration actuator according to the first or second exemplary embodiment is mounted on an optical apparatus.

FIG. 18 is a view illustrating an example where the vibration actuator according to the first or second exemplary embodiment is mounted on a manipulator.

FIGS. 19A and 19B are views illustrating a driving principle of a vibrator according to an exemplary embodiment of the present disclosure.

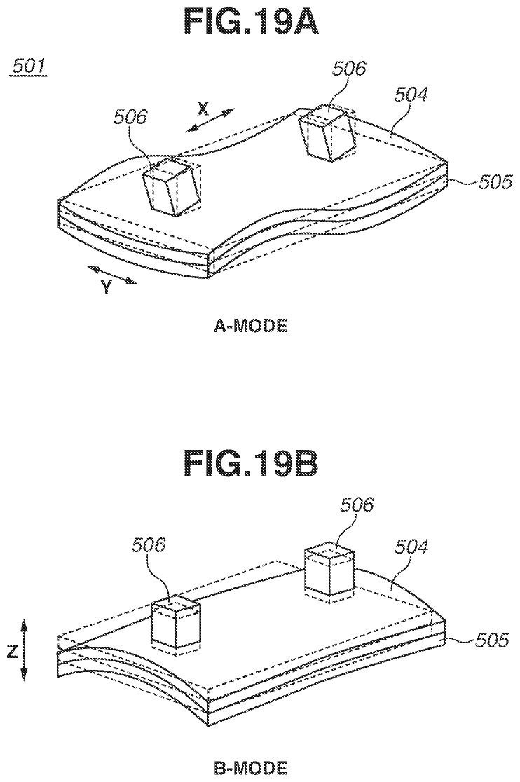

### DESCRIPTION OF THE EMBODIMENTS

An example of a vibration actuator according to an exemplary embodiment of the present disclosure is a vibration actuator including a vibrator and a contact body. The vibrator includes a rectangular elastic body and an electromechanical energy transducer. The contact body is configured to come into contact with the rectangular elastic body. The contact body and the vibrator are configured to move relative to each other due to vibration of the vibrator. The vibration actuator further includes at least one pair of first extensions and at least one pair of second extensions. The first extensions are disposed on each of two long sides of the rectangular elastic body and protrude in a direction intersecting a long-side direction of the rectangular elastic body. The second extensions are disposed on each of two short sides of the rectangular elastic body and protrude in a direction intersecting a short-side direction of the rectangular elastic body.

A detailed description will be given below with reference to the drawings.

In the following description, the term “contact body” refers to a member configured to come into contact with the vibrator and move relative to the vibrator due to the vibration generated in the vibrator. The contact between the contact body and the vibrator is not limited to direct contact without any other member interposed between the contact body and the vibrator. The contact between the contact body and the vibrator may be indirect with another member interposed between the contact body and the vibrator as long as the contact body can move relative to the vibrator due to the vibration generated in the vibrator. The term “another member” is not limited to a member (e.g., a high friction member made of a sintered body) independent of the contact body and the vibrator. The term “another member” includes a surface-treated portion of the contact body or the vibrator that is formed by plating or nitriding treatment.

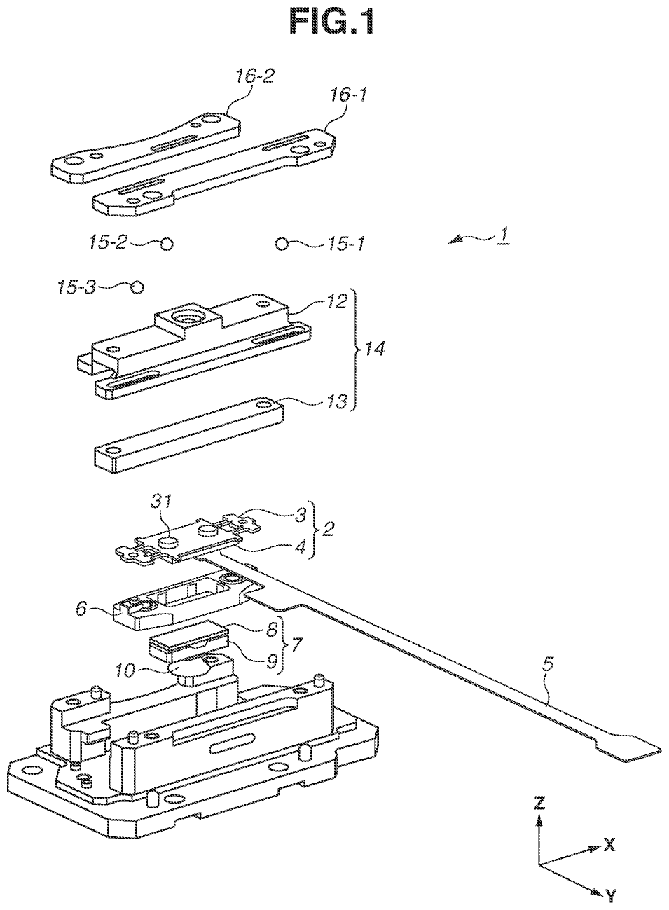

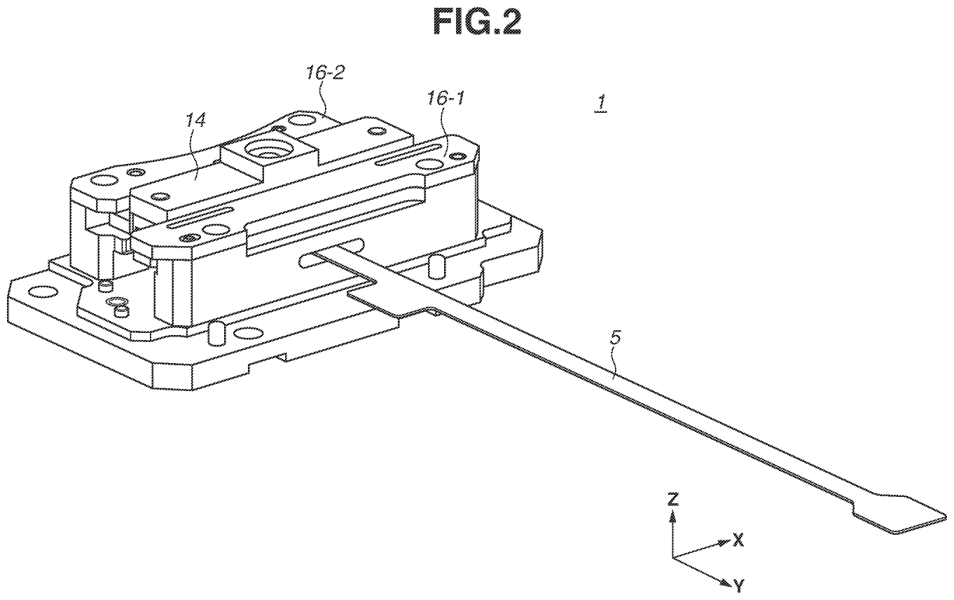

FIG. 1 is an exploded perspective view of a vibration actuator 1 according to a first exemplary embodiment of the present disclosure. FIG. 2 is a perspective view of the vibration actuator 1 in an assembled state. For convenience of description, mutually orthogonal X-, Y-, and Z-axes are defined as illustrated in FIG. 1. As will be described below, an X direction (or X-axis direction) is a direction parallel to a long-side direction of a contact body 13. A Z direction (or Z-axis direction) is a direction orthogonal to a frictional sliding surface of the contact body 13 sliding with a vibrator 2. A Y direction (or Y-axis direction) is a direction orthogonal to the X and Z directions.

The vibrator 2 includes a rectangular elastic body 3 (hereinafter referred to as an elastic body 3) that includes a plurality of projections 31 and a piezoelectric element 4 that is an electromechanical energy transducer. The elastic body 3 extends over an XY plane, and the piezoelectric element 4 is fixed by an adhesive to a surface of the elastic body 3 opposite to a surface thereof where the projections 31 protrude in the Z-axis direction. A flexible printed circuit board 5 for power supply is also fixed to a side of the piezoelectric element 4 opposite to a side thereof facing the elastic body 3. The flexible printed circuit board 5 is desirably fixed using an anisotropic conductive paste or anisotropic conductive film that enables energization only in the Z direction.

The elastic body 3 is desirably made of a material that does not attenuate vibration much. Examples of the material include stainless steel and ceramic. To drive the vibration actuator 1 according to the present exemplary embodiment in a high magnetic field environment like a magnetic resonance imaging (MRI) device, the elastic body 3 may also be made of a nonmagnetic material. The nonmagnetic material refers to a material with less attraction force to a magnetic field so that driving characteristics are not hampered due to the vibration actuator 1 being attracted in a magnetic field environment. Specific examples of the nonmagnetic material include austenite stainless steel, brass, phosphor bronze, aluminum alloys, and ceramic.

The elastic body 3 may be manufactured integrally with the projections 31 by press molding or cutting, or the projections 31 may be manufactured separately and then fixed to the elastic body 3 by welding or bonding.

The piezoelectric element 4 is formed using a piezoelectric material such as lead zirconate titanate. Alternatively, a lead-free piezoelectric material such as barium titanate may be used as a main component thereof. The term “lead-free” means that the lead content is 1000 ppm or less. The piezoelectric element 4 is formed of the piezoelectric material and electrodes. For example, not-illustrated electrode patterns are formed on both sides of a plate-like piezoelectric material. The flexible printed circuit board 5 feeds power to the piezoelectric element 4.

The vibrator 2 is retained by a vibrator retainer 6 (a vibrator retaining unit) using a method such as bonding or welding. A biasing member 10 applies a pressing force in the Z direction to the vibrator 2 via a pressure member 7 including a vibration attenuation member 8 and a pressure transmission member 9. The vibration attenuation member 8 can be made of felt. The vibrator 2 is thereby in contact with the contact body 13 with a predetermined pressing force. In this state, the pressure member 7 is in contact with only the vibrator 2 via a through portion formed in the vibrator retainer 6, whereby the pressing force generated by the biasing member 10 can be prevented from being transmitted to the vibrator retainer 6.

The contact body 13 is retained by a contact body retaining member 12, and the contact body 13 and the contact body retaining member 12 form a moving body 14. The moving body 14 and ball rails 16-1 and 16-2 sandwich rolling balls 15-1, -2, and 15-3 therebetween. The rolling balls 15-1, 15-2, and 15-3 roll in grooves extending in the X-axis direction in the contact body retaining member 12 and the ball rails 16-1 and 16-2, whereby the contact body 13 can move smoothly with respect to the vibrator 2 in the X direction, as a part of the moving body 14.

A detailed configuration of the vibrator 2 according to the present exemplary embodiment will now be described.

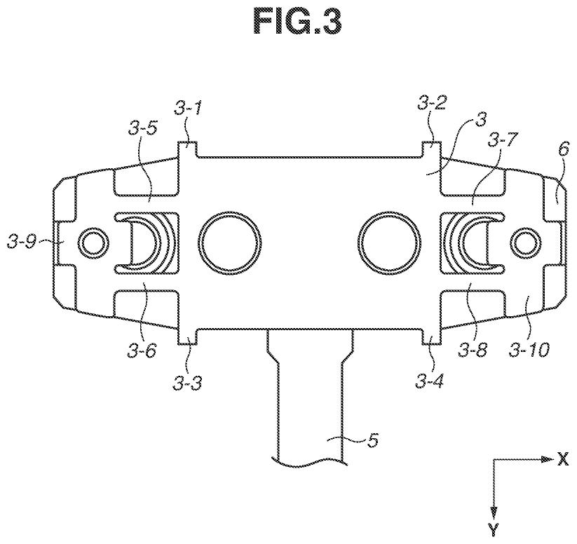

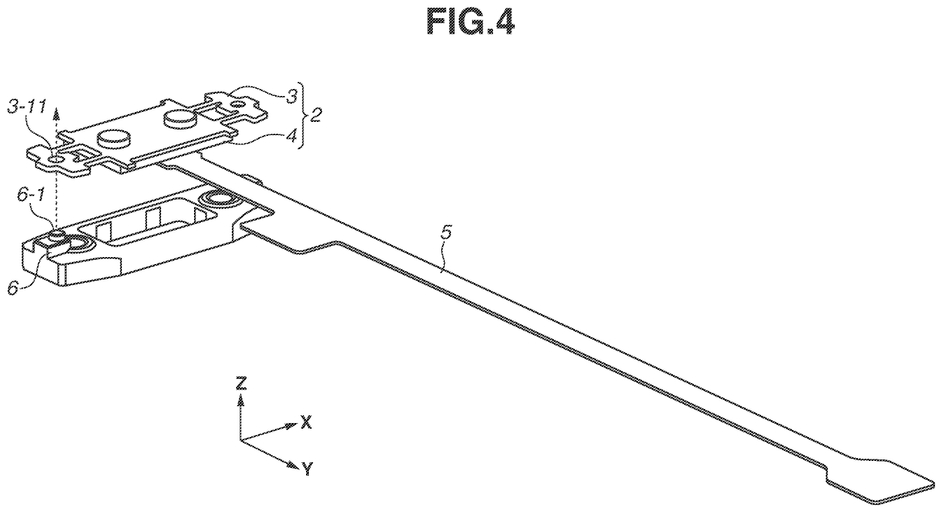

FIG. 3 is a view of the vibrator 2 according to the present exemplary embodiment, seen from a positive position to a negative position in the Z-axis direction. FIG. 3 mainly illustrates the elastic body 3. The elastic body 3 includes four second extensions 3-5, 3-6, 3-7, and 3-8 extending in the X direction within the XY plane, and four first extensions 3-1, 3-2, 3-3, and 3-4 extending in the Y direction. A retaining portion 3-9 is disposed at the ends of the second extensions 3-5 and 3-6 extending in the X direction, and a retaining portion 3-10 is disposed at the ends of the second extensions 3-7 and 3-8 extending in the X direction. As illustrated in FIG. 4, the retaining portion 3-9 has a hole 3-11, and the hole 3-11 is fitted to a projection 6-1 on the vibrator retainer 6 to retain the vibrator 2. In other words, the second extensions 3-5, 3-6, 3-7, and 3-8 have a function of retaining the vibrator 2. The elastic body 3 thus has a substantially rectangular shape within the XY plane, which is long in the X-axis direction and short in the Y direction.

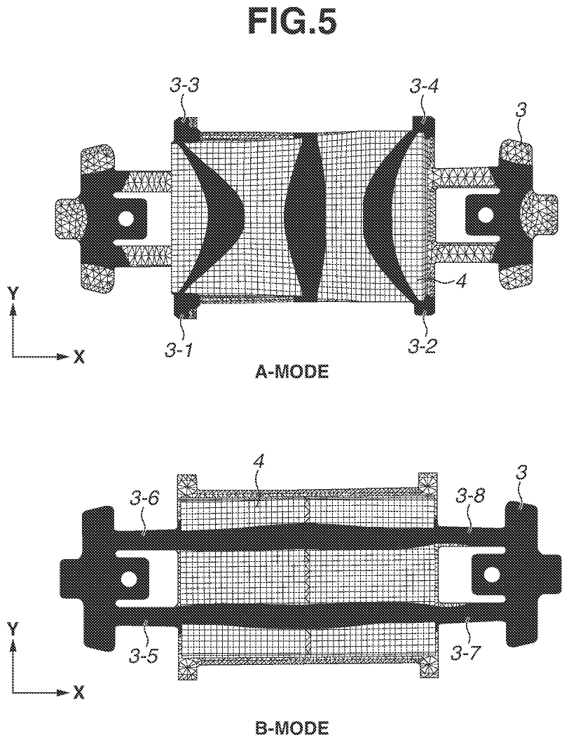

FIG. 5 illustrates a finite element method (FEM) analysis result on deformations in different vibration modes (A-mode and B-mode) generated in the vibrator 2. FIG. 5 is views of the vibrator 2 seen from a negative position to a positive position in the Z direction, i.e., from the piezoelectric element 4 side. Black portions represent areas where a displacement in the Z direction is small, i.e., represent nodes of bending vibration. The black portions are areas including nodal lines of vibration, where the displacement in the Z direction is small.

As illustrated in FIG. 5, the first extensions 3-1, 3-2, 3-3, and 3-4 are disposed near nodes of the A-mode. The second extensions 3-5, 3-6, 3-7, and 3-8 are disposed near nodes of the B-mode. In this way, the first extensions 3-1, 3-2, 3-3, and 3-4 are desirably disposed in pairs at both ends of two long sides of the elastic body 3 and may be disposed symmetrically about the center of the elastic body 3. The first extensions 3-1, 3-2, 3-3, and 3-4 can be configured to have substantially the same length in the protruding directions thereof.

In other words, in a case where the first and second bending vibration modes different from each other, i.e., the A-mode and the B-mode are respectively excited in the vibrator 2, the first extensions 3-1, 3-2, 3-3, and 3-4 are disposed in the proximity of the nodes of the vibration in the first bending vibration mode, and the second extensions 3-5, 3-6, 3-7, and 3-8 are disposed in the proximity of the nodes of the vibration in the second bending vibration mode. The proximity of the nodes refers to places illustrated in black where the displacement in the Z direction is small in an area extending in the extending direction of the nodal lines.

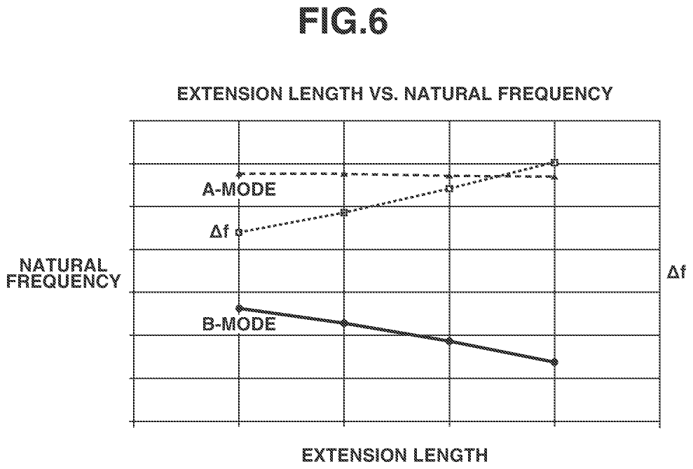

The effect of the first extensions 3-1, 3-2, 3-3, and 3-4 disposed on the elastic body 3 will be described. FIG. 6 is a graph illustrating a relationship between the lengths of the first extensions 3-1, 3-2, 3-3, and 3-4 and natural frequencies f_{A} and f_{B} in the A- and B-modes of the vibrator 2. The horizontal axis indicates the extension length. The lengths of the first extensions 3-1, 3-2, 3-3, and 3-4 increase to the right. The vertical axis indicates the values of the natural frequencies f_{A} and f_{B} in the A- and B-modes and a difference Δf (=f_{A}−f_{B}) between the natural frequencies f_{A} and f_{B}. The values increase upward. As illustrated in FIG. 6, as the lengths of the first extensions 3-1, 3-2, 3-3, and 3-4 decrease, the natural frequency f_{B} in the B-mode increases but the natural frequency f_{A} in the A-mode changes little. The reason is that the first extensions 3-1, 3-2, 3-3, and 3-4 are disposed near the nodes of the A-mode, whereby an influence on the natural frequency f_{A} in the A-mode can be reduced. The difference Δf thus decreases as the extension length decreases.

As described above, it is possible to change only the natural frequency f_{B} in the B-mode to adjust the difference Δf by changing the lengths of the first extensions 3-1, 3-2, 3-3, and 3-4 of the elastic body 3 extending in the Y direction within the XY plane. This can facilitate the adjustment of the difference Δf to an optimum value if the value of the difference Δf of the vibrator 2 deviates from the intended range as will be described below. The first extensions 3-1, 3-2, 3-3, and 3-4 extending in the Y direction may be disposed anywhere near the nodes of the A-mode. While in the present exemplary embodiment, two extensions are disposed on each of the opposed sides, one extension or three extensions may be disposed on each side. In the present exemplary embodiment, in a case where the lengths of the first extensions 3-1, 3-2, 3-3, and 3-4 are reduced by grinding or laser machining, the difference Δf is made somewhat large in advance because the value of the difference Δf can only be reduced.

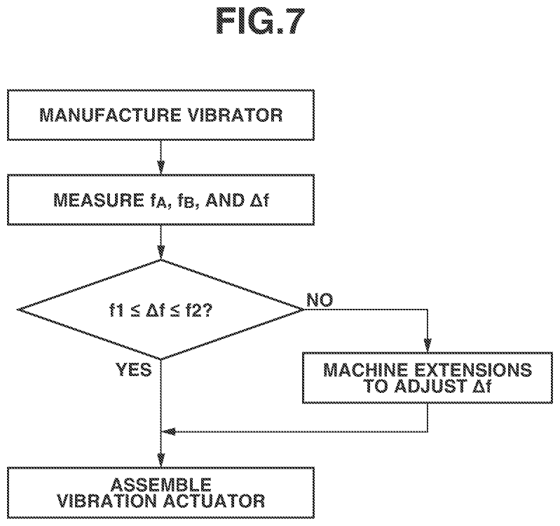

FIG. 7 is a flowchart illustrating a procedure for adjusting the lengths of the first extensions 3-1, 3-2, 3-3, and 3-4. In the flowchart, a predetermined range f1 to f2 is set for the difference Δf. If machining errors within the same manufacturing lot are large, machining the first extensions 3-1, 3-2, 3-3, and 3-4 is to be performed for all the vibrators 2 to adjust the difference Δf. If variations within the same lot are small, the amount of machining the first extensions 3-1, 3-2, 3-3, and 3-4 may be changed only when the lot is switched. More specifically, as long as the extension lengths in the same lot are made equal, it is unnecessary to perform the machining individually for the vibrators 2 in the same lot because the difference Δf is considered to fall within the predetermined range (f1≤Δf≤f2).

If the difference Δf does not vary between different lots, changing the amount of machining the first extensions 3-1, 3-2, 3-3, and 3-4 is unnecessary. As described above, it is possible to provide the vibration actuators 1 having a uniform difference Δf by machining the first extensions 3-1, 3-2, 3-3, and 3-4 after manufacturing the vibrators 2.

In the present exemplary embodiment, the second extensions 3-5, 3-6, 3-7, and 3-8 are integrally formed with the elastic body 3. Alternatively, the second extensions 3-5, 3-6, 3-7, and 3-8 may be formed separately and attached to the elastic body 3 using a method such as bonding or welding.

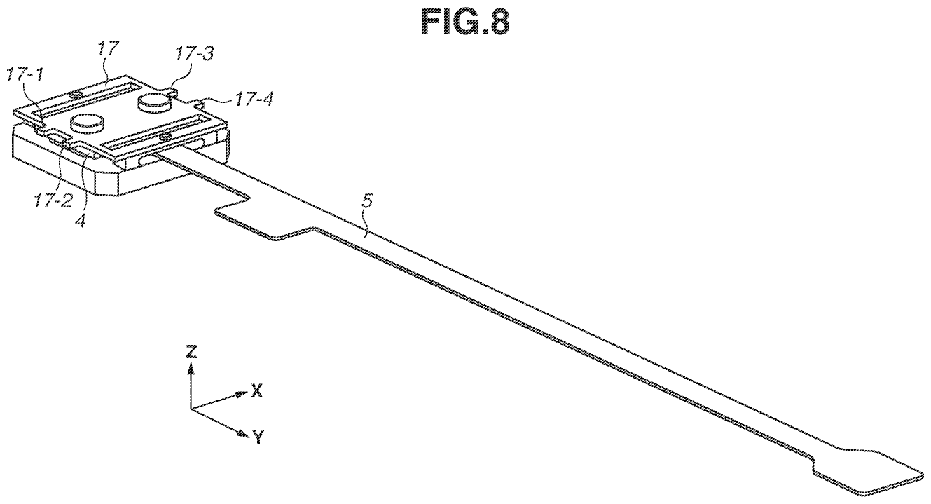

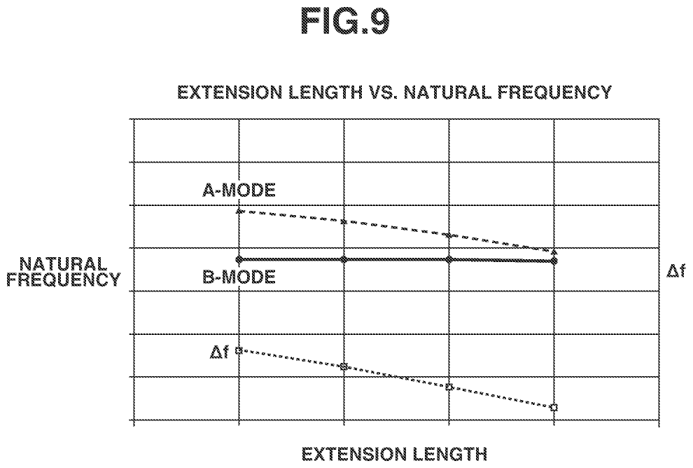

The elastic body 3 may be shaped like an elastic body 17 illustrated in FIG. 8, where retaining portions are disposed on second extensions 17-1, 17-2, 17-3, and 17-4 extending in the X-axis direction. In this case, as illustrated in a graph of FIG. 9, as the lengths of the second extensions 17-1, 17-2, 17-3, and 17-4 extending in the X-axis direction decrease, the natural frequency f_{A} in the A-mode increases but the natural frequency f_{B} in the B-mode changes little. The reason is that the second extensions 17-1, 17-2, 17-3, and 17-4 are disposed near the nodes of the B-mode, whereby an influence on the natural frequency f_{B} in the B-mode can be reduced. The difference Δf (=f_{A}−f_{B}) thus increases as the lengths of the second extensions 17-1, 17-2, 17-3, and 17-4 are reduced.

In the present exemplary embodiment, in a case where the lengths of the second extensions 17-1, 17-2, 17-3, and 17-4 are reduced by grinding or laser machining, the difference Δf is made somewhat small in advance because the value of the difference Δf can only be increased.

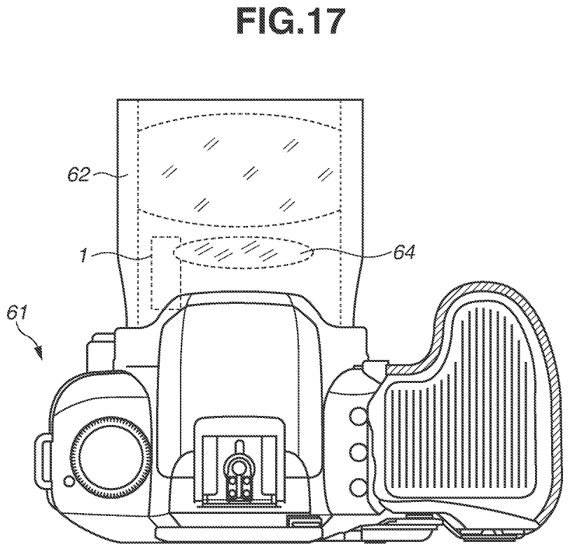

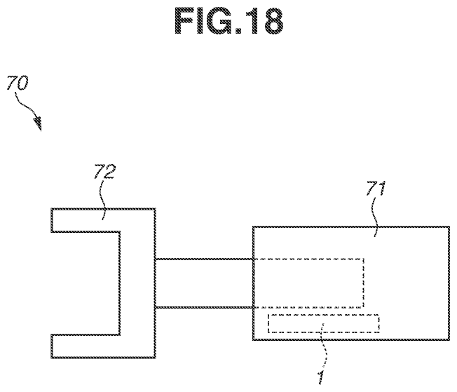

For example, as illustrated in FIG. 17, the vibration actuator 1 according to the exemplary embodiment can be disposed inside a lens barrel 62 detachably attached to a camera main body 61, and used as a driving source of a zoom lens (or a focus adjustment lens) 64. Alternatively, as illustrated in FIG. 18, the vibration actuator 1 can be used in a manipulator 70 as a driving source of a hand 72 extendable and contractable with respect to a support unit 71.

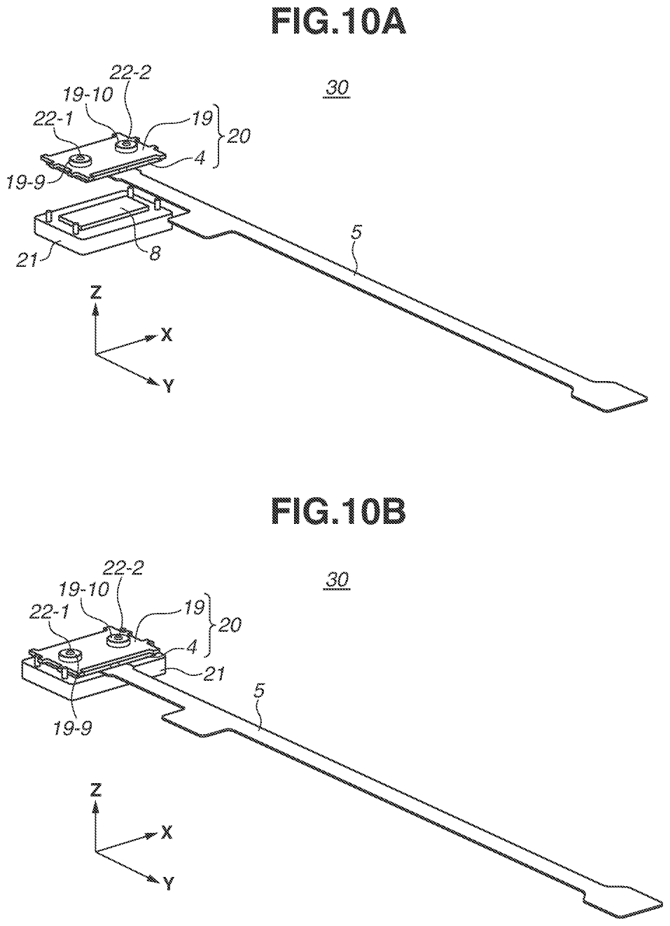

FIG. 10A is an exploded perspective view of a vibrator 20 and a pressure member 21 mounted in a vibration actuator according to a second exemplary embodiment of the present disclosure. FIG. 10B is a view illustrating a combination of the vibrator 20 and the pressure member 21 in the vibration actuator according to the present exemplary embodiment. The combination of the vibrator 20 and the pressure member 21 will hereinafter be referred to as a vibrator unit 30. The vibration actuator according to the present exemplary embodiment corresponds, for example, to the vibration actuator 1 according to the first exemplary embodiment that is modified in the vibrator-related configuration.

In FIG. 10A, the vibration attenuation member 8 is disposed between an elastic body 19 and the pressure member 21 so that the vibration generated in the vibrator 20 is not transmitted to the pressure member 21.

The pressure member 21 is configured to receive a pressing force from a not-illustrated biasing member and transmit the pressing force to the vibrator 20 via the vibration attenuation member 8.

Projections 19-9 and 19-10 in the Z-axis direction, which is the pressing direction, are disposed on the surface of the elastic body 19. The piezoelectric element 4 is fixed by an adhesive to a surface of the elastic body 19 opposite to a surface thereof where the projections 19-9 and 19-10 are disposed. The flexible printed circuit board 5 is fixed to a surface of the piezoelectric element 4 opposite to a surface thereof bonded to the elastic body 19. The adhesion method is similar to that in the first exemplary embodiment. The electrode patterns and the material of the piezoelectric element 4 are also similar to those in the first exemplary embodiment.

The elastic body 19 is integrally formed by pressing or cutting. Friction members 22-1 and 22-2 are fixed to the tops of the projections 19-9 and 19-10, respectively, using a method such as bonding or welding. The friction members 22-1 and 22-2 are made of a material having high abrasion resistance. With such a configuration, the elastic body 19 can be made of a material having low abrasion resistance, such as aluminum alloys, copper alloys, or resins.

Such a configuration can improve the durability of the vibration actuator because the friction members 22-1 and 22-2 having excellent abrasion resistance come into contact with the contact body 13. As in the first exemplary embodiment, the elastic body 19 may be integrally formed with the friction members 22-1 and 22-2, using a material that has high abrasion resistance and does not attenuate vibration much, like stainless steel or ceramic.

A configuration of the vibrator unit 30 according to the present exemplary embodiment will now be described.

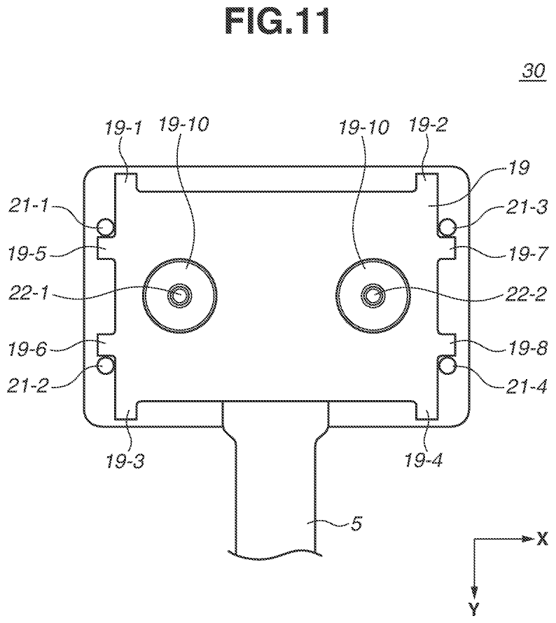

FIG. 11 is a view of the vibrator unit 30 seen in the pressing direction (the Z-axis direction). In the present exemplary embodiment, a member for retaining the elastic body 19 is not provided. Instead, positioning projections 21-1, 21-2, 21-3, and 21-4 disposed on the pressure member 21 are engaged with second extensions 19-5, 19-6, 19-7, and 19-8 of the elastic body 19 extending in the X-axis direction. With such a configuration, the vibrator 20 is prevented from moving relative to the pressure member 21 in the X and Y directions.

In the vibrator unit 30 illustrated in FIG. 11, suppose that the lengths of the first extensions 19-1, 19-2, 19-3, and 19-4 extending in the Y-axis direction are changed by removal machining. As a result, it is possible to reduce the difference Δf by only increasing the natural frequency f_{B} in the B-mode without changing the natural frequency f_{A} in the A-mode, as illustrated in the graph of FIG. 6.

If the lengths of the second extensions 19-5, 19-6, 19-7, and 19-8 extending in the X-axis direction are changed by removal machining, it is possible to increase the difference Δf by only increasing the natural frequency f_{A} in the A-mode without changing the natural frequency f_{B} in the B-mode, as with the graph of FIG. 9.

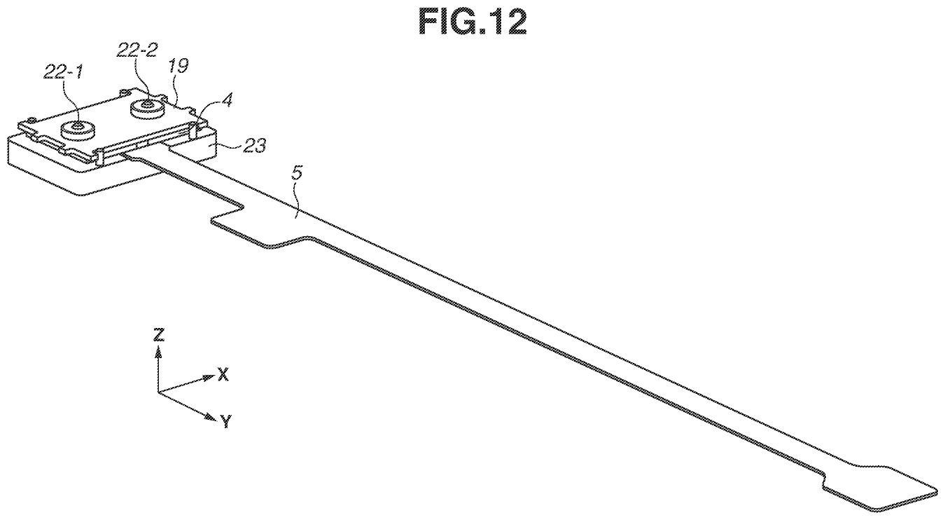

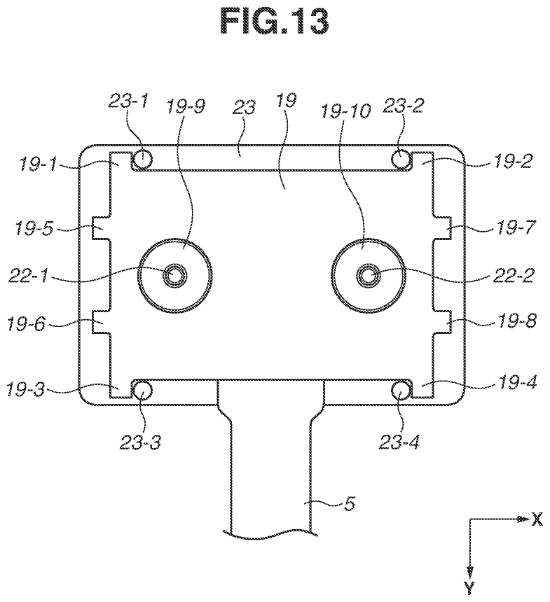

If the lengths of the second extensions 19-5, 19-6, 19-7, and 19-8 extending in the X direction are reduced, it is difficult for the second extensions 19-5, 19-6, 19-7, and 19-8 to engage with the positioning projections 21-1, 21-2, 21-3, and 21-4 disposed on the pressure member 21, respectively. In such a case, a pressure member 23 illustrated in FIG. 12 may be used. As illustrated in FIG. 13, positioning projections 23-1, 23-2, 23-3, and 23-4 disposed on the pressure member 23 are engaged with the first extensions 19-1, 19-2, 19-3, and 19-4 extending from the elastic body 19 in the Y direction, respectively. As a result, the elastic body 19 is positioned and retained with respect to the pressure member 23.

As illustrated in FIG. 11 or 13, the vibrator 20 and the contact body 13 are brought into press contact with each other by the pressure member 21 or 23. The pressure member 21 or 23 is in contact with the vibrator 20 via the vibration attenuation member 8. The vibration actuator can be configured so that the vibrator 20 is supported by engagement of the plurality of positioning projections described above on the pressure member 21 or 23 with either the first extensions 19-1, 19-2, 19-3, and 19-4 or the second extensions 19-5, 19-6, 19-7, and 19-8.

In the present exemplary embodiment, unlike the first exemplary embodiment, there are no retaining portions for retaining the vibrator 20 at the ends of the extensions extending from the elastic body 19. The first extensions 19-1, 19-2, 19-3, and 19-4 extending in the Y direction and the second extensions 19-5, 19-6, 19-7, and 19-8 extending in the X direction can thus be both changed in length at the same time. The difference Δf can be adjusted to increase or decrease by applying removal machining to either the first extensions 19-1, 19-2, 19-3, and 19-4 or the second extensions 19-5, 19-6, 19-7, and 19-8.

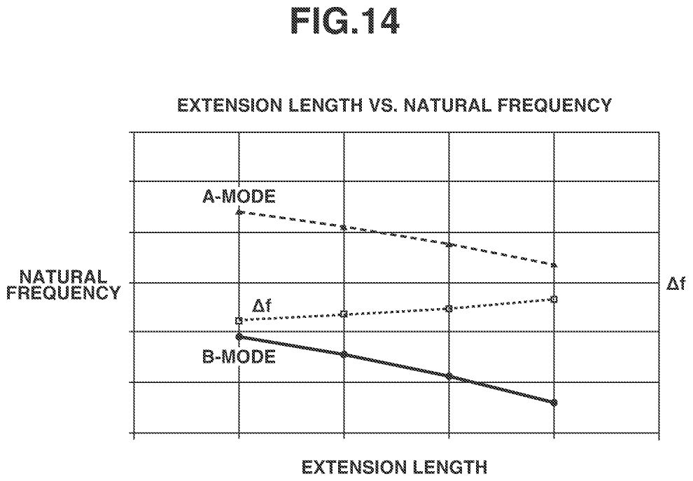

FIG. 14 illustrates changes in the natural frequencies f_{A} and f_{B} in the A- and B-modes and the difference Δf in a case where the lengths of the first extensions 19-1, 19-2, 19-3, and 19-4 and the lengths of the second extensions 19-5, 19-6, 19-7, and 19-8 are changed by equal amounts. If the lengths of the first extensions 19-1, 19-2, 19-3, and 19-4 and the lengths of the second extensions 19-5, 19-6, 19-7, and 19-8 are reduced by removal machining, the natural frequencies f_{A} and f_{B} in the A- and B-modes increase by substantially the same amount, whereas the difference Δf (=f_{A}−f_{B}) does not change much. As described above, it is possible to make the natural frequencies f_{A} and f_{B} of the vibrator 20 uniform by simultaneously changing the lengths of the first extensions 19-1, 19-2, 19-3, and 19-4 extending in the Y-axis direction and the lengths of the second extensions 19-5, 19-6, 19-7, and 19-8 extending in the X-axis direction. As a result, the difference Δf can be adjusted to be within the predetermined range f1 to f2, and the processes of selecting the natural frequencies f_{A} and f_{B} can be reduced or eliminated in driving a plurality of the vibrators 20 using a single driving circuit. While in the present exemplary embodiment, the lengths of the first extensions 19-1, 19-2, 19-3, and 19-4 and the lengths of the second extensions 19-5, 19-6, 19-7, and 19-8 are described to be changed by the same amount, the change amount may be set differently for the first extensions 19-1, 19-2, 19-3, and 19-4 and the second extensions 19-5, 19-6, 19-7, and 19-8.

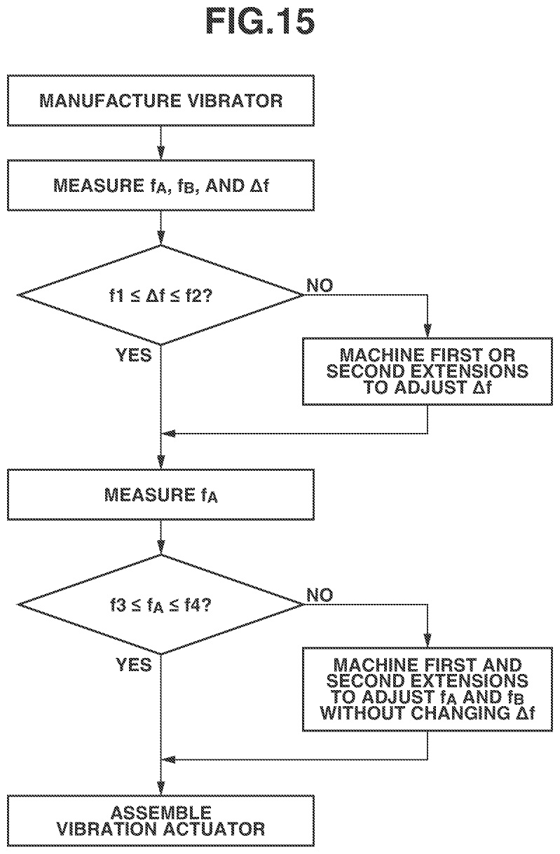

FIG. 15 is a flowchart illustrating a procedure for uniformizing the difference Δf and the natural frequencies f_{A} and f_{B}. In the flowchart, the predetermined range f1 to f2 is set for the difference Δf, and a range f3 to f4 is set for the natural frequency f_{A} in the A-mode.

Initially, if the condition of f1≤Δf≤f2 is not satisfied, either the first extensions 19-1, 19-2, 19-3, and 19-4 extending in the Y-axis direction or the second extensions 19-5, 19-6, 19-7, and 19-8 extending in the X-axis direction are subjected to removal machining so that the difference Δf falls within the predetermined range f1 to f2. Then, the first extensions 19-1, 19-2, 19-3, and 19-4 extending in the Y-axis direction and the second extensions 19-5, 19-6, 19-7, and 19-8 extending in the X-axis direction are subjected to removal machining to satisfy the condition of f3≤f_{A}≤f4 without changing the difference Δf. As described above, it is possible to provide the vibration actuators having uniform difference Δf and natural frequencies f_{A} and f_{B} by manufacturing the vibrators 20 and then applying the removal machining to the first extensions 19-1, 19-2, 19-3, and 19-4 and the second extensions 19-5, 19-6, 19-7, and 19-8.

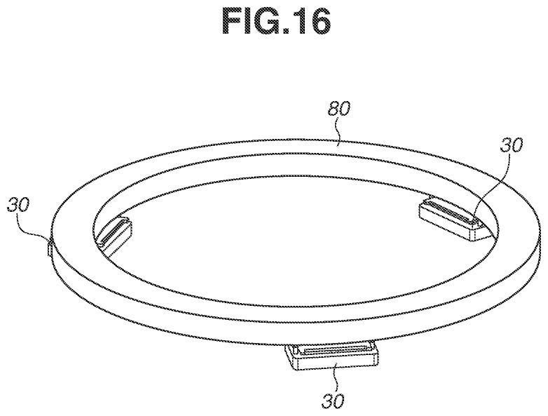

FIG. 16 is a schematic view of a configuration for driving an annular contact body 80 (hereinafter referred to as a contact body 80) using a plurality of the vibrator units 30. The contact body 80 is hollow and, for example, with a lens held therein, can be used as a driving source for an autofocus or zoom operation where the rotation of the contact body 80 is converted into a linear motion to move the lens. With a camera mounted thereon, the contact body 80 can also be used as a driving source for a pan operation.

The plurality of vibrator units 30 is brought into press contact with the contact body 80 by not-illustrated pressure units. The pressure units may be coil springs or other type of springs such as plate springs or tension springs. The vibrator units 30 may be magnetically pressed. If the plurality of vibrator units 30 is used as described above and the vibrator units 30 vary in the natural frequency bands, unit-by-unit differences in speed can affect durability and controllability. By contrast, in the present exemplary embodiment, the driving frequency bands of the vibrator units 30 can be made uniform by adjusting the lengths of the first extensions 19-1, 19-2, 19-3, and 19-4 and the lengths of the second extensions 19-5, 19-6, 19-7, and 19-8. In other words, individual differences between the vibrator units 30 can be reduced to provide excellent characteristics.

The foregoing vibration actuators can be suitably used for optical apparatuses and manipulators.

The natural frequencies f_{A} and f_{B} and the difference Δf of the vibration actuators can be adjusted by machining the extensions extending within the plane perpendicular to the pressing direction of the vibrators to change the extension lengths.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described Embodiments and/or that includes one or more circuits (e.g., application specific integrated circuit (ASIC)) for performing the functions of one or more of the above-described Embodiments, and by a method performed by the computer of the system or apparatus by, for example, reading out and executing the computer executable instructions from the storage medium to perform the functions of one or more of the above-described Embodiments and/or controlling the one or more circuits to perform the functions of one or more of the above-described Embodiments. The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-185025, filed Nov. 18, 2022, which is hereby incorporated by reference herein in its entirety.

What is claimed is:

1. A vibration actuator comprising:
a vibrator including a rectangular elastic body and an electromechanical energy transducer;
a contact body configured to come into contact with the rectangular elastic body, wherein the contact body and the vibrator are configured to move relative to each other due to vibration of the vibrator;
at least one pair of first extensions disposed on each of two long sides of the rectangular elastic body, and protruding in a direction intersecting a long-side direction of the rectangular elastic body; and
at least one pair of second extensions disposed on each of two short sides of the rectangular elastic body, and protruding in a direction intersecting a short-side direction of the rectangular elastic body.

2. The vibration actuator according to claim 1, wherein one pair of the at least one pair of first extensions are disposed at both ends of each of the two long sides.

3. The vibration actuator according to claim 2, wherein the at least one pair of first extensions are disposed symmetrically about a center of the rectangular elastic body.

4. The vibration actuator according to claim 1, wherein the at least one pair of first extensions have substantially a same length in protruding directions thereof.

5. The vibration actuator according to claim 1,
wherein the vibrator is configured to excite each of a first bending vibration mode and a second bending vibration mode that are different from each other,
wherein the at least one pair of first extensions are disposed near nodes of the vibration in the first bending vibration mode, and
wherein the at least one pair of second extensions are disposed near nodes of the vibration in the second bending vibration mode.

6. The vibration actuator according to claim 1, wherein either the at least one pair of first extensions or the at least one pair of second extensions support the vibrator at a predetermined position.

7. The vibration actuator according to claim 6,
wherein the vibrator and the contact body are brought into press contact with each other by a pressure member, and
wherein the pressure member is in contact with the vibrator via a vibration attenuation member and supports the vibrator by engaging a plurality of projections of the pressure member with either the at least one pair of first extensions or the at least one pair of second extensions.

8. The vibration actuator according to claim 6, wherein either the at least one pair of first extensions or the at least one pair of second extensions are retained by a vibrator retaining unit.

9. The vibration actuator according to claim 1, wherein the rectangular elastic body is made of a nonmagnetic material.

10. The vibration actuator according to claim 9, wherein the nonmagnetic material includes at least one material selected from among austenite stainless steel, brass, phosphor bronze, an aluminum alloy, and ceramic.

11. The vibration actuator according to claim 9, wherein the at least one pair of second extensions are made of the nonmagnetic material.

12. The vibration actuator according to claim 9, wherein the contact body is made of the nonmagnetic material.

13. A method for manufacturing a vibration actuator including a vibrator and a contact body, wherein the vibrator includes a rectangular elastic body and an electromechanical energy transducer, the contact body is configured to come into contact with the rectangular elastic body, and the contact body and the vibrator are configured to move relative to each other due to vibration of the vibrator, the method comprising:
disposing at least one pair of first extensions on each of two long sides of the rectangular elastic body, and at least one pair of second extensions on each of two short sides of the rectangular elastic body; and
adjusting a difference Δf between natural frequencies fA and fB of two different bending vibrations of the vibrator by machining the at least one pair of first extensions or the at least one pair of second extensions.

14. A method for manufacturing a vibration actuator including a vibrator and a contact body, wherein the vibrator includes a rectangular elastic body and an electromechanical energy transducer, the contact body is configured to come into contact with the rectangular elastic body, and the contact body and the vibrator are configured to move relative to each other due to vibration of the vibrator, the method comprising:
disposing at least one pair of first extensions on each of two long sides of the rectangular elastic body, and at least one pair of second extensions on each of two short sides of the rectangular elastic body;
adjusting a difference Δf between natural frequencies fA and fB of two bending vibrations of the vibrator to be within a predetermined range by machining the at least one pair of first extensions or the at least one pair of second extensions; and
adjusting the natural frequencies fA and fB of the vibrator to be within a predetermined range by machining the at least one pair of first extensions and the at least one pair of second extensions.
